(19) United States
(12) Patent Application Publication
(10) Pub. No.: US 2025/0181032 A1
(43) Pub. Date: Jun. 5, 2025

(54) MAGNETIC INDEXING SYSTEM FOR A DISPLAY

(71) Applicant: Montres Breguet S. A., L'Abbaye (CH)

(72) Inventors: Christophe RIEDO, Le Lieu (CH); Pedro PASANDIN PENA, L'Orient (CH); Jonas FAVRE, Veigy-Foncenex (FR)

(73) Assignee: Montres Breguet S.A., L'Abbaye (CH)

(21) Appl. No.: 18/920,181

(22) Filed: Oct. 18, 2024

(30) Foreign Application Priority Data
Nov. 30, 2023 (EP) 23213435.3

(51) Int. Cl. G04B 19/257

(52) U.S. Cl. CPC G04B 19/2573

(57) ABSTRACT

A magnetic indexing system (10) for a display (12) including a structural element (11) and a display (12) arranged movably relative to the structural element (11), a pair of magnetic elements (13, 14) having an anchoring portion (130, 140) by which a first magnetic element (13) is fastened to the structural element (11) and a second magnetic element (14) is fastened to the display (12), the magnetic elements being configured to cooperate with each other so as to generate a positioning torque of the display adapted to maintain the latter in a predetermined angular position with respect to the structural element (11), the magnetic elements including an interaction portion (131, 141) by which they are intended to face each other, the interaction portion of the first or second magnetic element having a cross-section reduced relative to that of its anchoring portion.

### CROSS REFERENCE TO RELATED APPLICATIONS

This application is claiming priority based on European Patent Application No. 23213435.3 filed on Nov. 30, 2023.

### TECHNICAL FIELD OF THE INVENTION

The invention relates to the watchmaking field and in particular to horological movements. The invention relates in particular to a magnetic indexing system for a display.

The term “indexing” is well-known to a person skilled in the art for designating the act of imposing a specific orientation on a moving object. In the context of the present invention, indexing is carried out so as to impose a linear or angular position on an object that is movable in translation or rotation respectively.

### TECHNOLOGICAL BACKGROUND

In a watch display mechanism, the relative positioning of a display with respect to a reference point such as another display or a fixed structure is particularly important as it is a visible element. The problem of relative positioning of displays is always tricky to solve, as any misalignment, however slight, is highly visible to the user.

It's clear that the proper positioning of a display is a guarantee of quality, and that the wrong positioning could be very damaging to the image of a watch brand.

For example, “large date” date display devices are well known and include two contiguous displays indicating respectively a ten and a unit representing the current date. These two displays are oriented in relation to each other so as to give the illusion of one single display, or at least so that the digits they show are aligned with each other. As each display has its own drive mechanism to ensure that it rotates and remains in position, the proper relative positioning of the displays is particularly complex to achieve.

Among known indexing solutions, mechanical solutions lead to premature wear of the components making up the drive mechanism, due to the frictions generated and any shocks that might occur and/or kinking phenomena, which could also lead to undesirable noises.

### SUMMARY OF THE INVENTION

The invention solves the aforementioned drawbacks and to this end relates to a magnetic indexing system for a display comprising a structural element and a display movably arranged relative to the structural element, a pair of magnetic elements including an anchoring portion by which a first magnetic element is fastened to the structural element and a second magnetic element is fastened to the display.

The magnetic elements are configured to cooperate with each other so as to generate a positioning torque for the display adapted to maintain the latter in a predetermined angular position with respect to the structural element. The magnetic elements comprising an interaction portion by which they are intended to face each other, the interaction portion of the first or second magnetic element having a reduced cross-section relative to that of its anchoring portion.

Thanks to these features, the invention allows compensating for any indexing errors caused by mechanical play created between the teeth of a drive mechanism of the display.

Moreover, the invention enables the display to be repositioned, i.e. indexed, following an impact.

In particular embodiments, the invention may further include one or more of the following features, considered alone or in any technically possible combination.

In particular embodiments, the interaction portion of the first or second magnetic element has an annular shoulder so as to form a central projection.

In particular embodiments, the interaction portion of the first or second magnetic element has a triangular cross-section.

In particular embodiments, the interaction portion of the first or second magnetic element has two opposing inclined sides connected to each other by a median portion.

In particular embodiments, the interaction portion of the first or second magnetic element has a conical shape.

In particular embodiments, the interaction portion of the first or second magnetic element has an axisymmetrically conical shape.

In particular embodiments, the interaction portion of the first or second magnetic element has a pyramidal shape.

According to another object, the present invention relates to a horological movement comprising an indexing system as described before and a roller display device, the structural element being formed by a flange and the display being formed by a roller comprising a support structure to which flaps are fastened movable in rotation.

### BRIEF DESCRIPTION OF THE FIGURES

Other features and advantages of the invention will become apparent from the following detailed description, given as a non-limiting example, with reference to the appended drawings wherein:

FIG. 1 shows, in an example of application of the invention, a perspective view of a roller display device in which a magnetic indexing system according to the present invention is integrated,

FIG. 2 shows a perspective view of a display unit of the display device of FIG. 1,

FIGS. 3a to 3d each schematically shows a perspective view of a pair of magnetic elements of an indexing system according to embodiments of the invention.

Note that the figures are not necessarily drawn to scale for clarity.

### DETAILED DESCRIPTION OF THE INVENTION

The present invention relates to a magnetic indexing system 10 for a display and is described hereinafter in a preferred example of application in which it is incorporated into a roller display device 20.

For example, such a roller display device may be in accordance with that described in patent EP3627240.

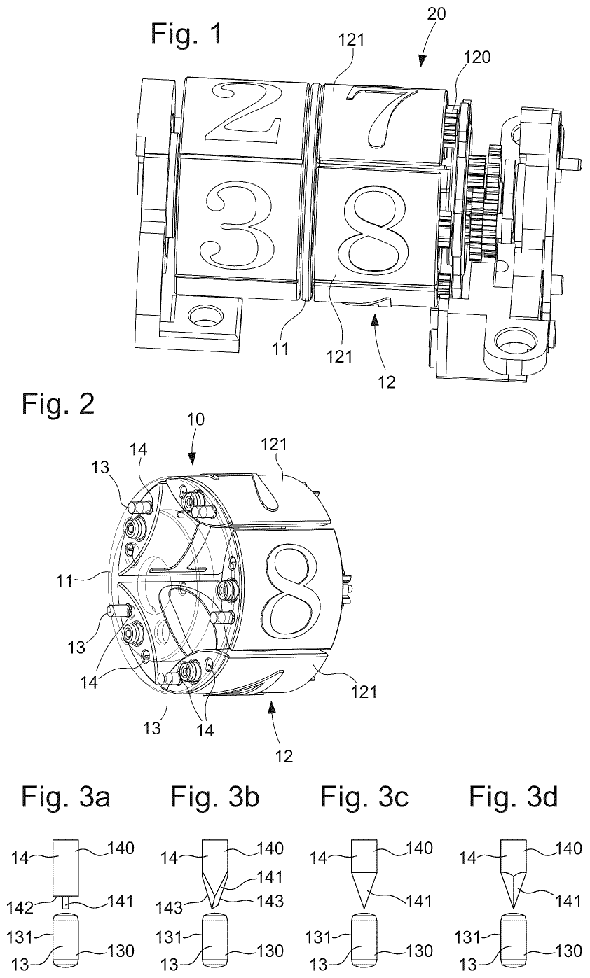

The magnetic indexing system 10 according to the invention comprises a structural element 11 and a display 12 arranged so as to be movable relative to the structural element 11. In the example of application of the invention shown in FIGS. 1 and 2, the structural element 11 is formed by a flange, for example intended to be fastened without any degree of freedom to a bridge or a plate, and the display 12 is formed by a display roller including a support structure 120 intended to be mounted movable in rotation relative to the structural element 11, and to which flaps 121 are fastened movable in rotation. In other examples of application of the invention, the structural element 11 may be formed by any structure of a horological movement, such as a bridge or a plate, and the display 12 may be formed by a disc, a strip, etc.

The magnetic indexing system 10 also includes at least one pair of magnetic elements, both of which are fastened respectively, by an anchoring portion 130, 140, to the structural element 11 and to the display 12. In particular, a first magnetic element 13 of the pair of magnetic elements is fastened to the flange, facing the trajectory of a flap 121, and at least a second magnetic element 14 of the pair is fastened to a field of the flap 121. The anchoring portion 130, 140 is cylindrical in shape, preferably axisymmetrically cylindrical. The first and second magnetic elements 13 and 14 are fastened by driving in or by gluing, to the structural element 11 and the display 12, respectively, in a manner known per se to a person skilled in the art.

It should be noted that, in the present text, different second magnetic elements 14 may successively form a pair of magnetic elements with the same first magnetic element 13.

The first and second magnetic elements 13 and 14 are configured to cooperate with each other thanks to the establishment of a magnetic attraction force, so as to generate a positioning torque for the display 12, adapted to maintain the latter in a predetermined angular position relative to the structural element 11.

Advantageously, the first and second magnetic elements 13 and 14 comprise, opposite their anchoring portion 130, 140, an interaction portion 131, 141 extending up to an interaction end at which they are intended to face each other. The cross-section of the interaction portion 131 or 141 of the first or second magnetic element 13 or 14 is reduced relative to that of its anchoring portion 130 or 140.

This feature allows centring the field lines of the first or second magnetic element 13 or 14, and therefore ensuring that the flap 121 is properly positioned relative to the flange. This feature also allows minimising the force of attraction between the first and second magnetic elements 13 and 14, which has the effect of minimising the frictions of the flaps 121 on the support structure 120, and consequently, contributing in reducing the range of static equilibrium between the first and second magnetic elements 13 and 14.

Thanks to the present invention, the accuracy of the indexing of the flaps 121 is therefore substantially improved.

In some embodiments of the invention, the interaction portion 131 or 141 of the first or second magnetic element 13 or 14 may have an annular shoulder 142 so as to form a central projection, as illustrated in FIG. 3a.

In the embodiments of the invention shown in FIGS. 3b to 3d, the interaction portion 141 of the second magnetic element 14 has a triangular cross-section.

In particular, in the example shown in FIG. 3b, the interaction portion 141 of the second magnetic element 14 has two opposing inclined sides 143 connected to each other by a median portion. The median portion forms the interaction end and has the shape of a segment.

In the embodiment illustrated in FIGS. 3c and 3d, the interaction portion 141 of the second magnetic element 14 has a conical shape, the interaction end being materialised by a point. The interaction portion 141 of the second magnetic element 14 may have an axisymmetrically conical shape, as shown in FIG. 3c, or a pyramidal shape, as shown in FIG. 3d.

It should be noted that the interaction portion shapes described hereinabove and visible in FIGS. 3a to 3d may alternatively or additionally apply to the interaction portion 131 of the first magnetic element 13.

In the or each pair of magnetic elements, at least one magnetic element is made of a hard ferromagnetic material, i.e. it forms a permanent magnet, the other magnetic element could be made of a soft ferromagnetic material. Preferably, only the interaction portion of the magnetic element made of soft ferromagnetic material has a reduced cross-section.

More generally, it should be noted that the methods of implementation and manufacture considered hereinabove have been described as non-limiting examples, and that other variants are therefore conceivable.

It should be noted that the air gap, i.e. the distance between the first and second magnetic elements 13 and 14 of a pair is, for example, in the range from 10 to 100 μm, or from 20 to 40 μm.

1. A magnetic indexing system for a display comprising:
a structural element;
a display movably arranged relative to the structural element;
a pair of magnetic elements including an anchoring portion by which a first magnetic element is fastened to the structural element and a second magnetic element is fastened to the display,
the magnetic elements being configured to cooperate with each other so as to generate a positioning torque of the display adapted to maintain the display in a predetermined angular position with respect to the structural element,
the magnetic elements comprising an interaction portion by which they are intended to face each other, the interaction portion of the first or second magnetic element having a cross-section reduced relative to that of its anchoring portion, the interaction portion of the first or second magnetic element having an annular shoulder so as to form a central projection or having a triangular-shaped cross-section.

2. The indexing system according to claim 1, wherein the interaction portion of the first or second magnetic element has two opposing inclined faces connected to each other by a median portion.

3. The indexing system as claimed in claim 1, wherein the interaction portion of the first or second magnetic element has a conical shape.

4. The indexing system according to claim 3, wherein the interaction portion of the first or second magnetic element has an axisymmetrically conical shape.

5. The indexing system according to claim 3, wherein the interaction portion of the first or second magnetic element has a pyramidal shape.

6. A horological movement comprising the indexing system according to claim 1 and a roller display device, the structural element being formed by a flange and the display being formed by a roller comprising a support structure to which flaps are fastened movable in rotation.
